(19) United States
(12) Patent Application Publication
(10) Pub. No.: US 2009/0179740 A1
(43) Pub. Date: Jul. 16, 2009

(54) RADIO FREQUENCY IDENTIFICATION (RFID) METHOD AND APPARATUS FOR MAXIMIZING RECEIVE CHANNEL SIGNAL-TO-NOISE RATIO BY ADJUSTING PHASE TO MINIMIZE NOISE

(75) Inventors: Vijay Pillai, Mukilteo, WA (US); James R. Peternel, Edmonds, WA (US)

Correspondence Address: SEED INTELLECTUAL PROPERTY LAW GROUP PLLC, 701 FIFTH AVE, SUITE 5400, SEATTLE, WA, 98104, US

(73) Assignee: INTERMEC IP CORP., Everett, WA (US)

(21) Appl. No.: 12/350,796

(22) Filed: Jan. 8, 2009

Related U.S. Application Data
(60) Provisional application No. 61/020,303, filed on Jan. 10, 2008.

(51) Int. Cl. H04Q 5/22

(52) U.S. Cl. 340/10.1

(57) ABSTRACT

Noise in a receive path of a radio frequency identification (RFID) reader is reduced by using a phase shifter. By reducing the noise, the signal-to-noise ratio (SNR) in the receive path of the RFID reader is improved, thereby increasing the number of RFID tags that can be read in a noisy environment over time and/or improving the capability to distinguish a return signal of the RFID tag(s) from noise. The phase shifter adds a phase shift to a reflected signal and a leakage signal, or to a local oscillation signal.

### CROSS REFERENCE TO RELATED APPLICATIONS

This application claims benefit under 35 U.S.C. 119(e) to U.S. provisional patent application Ser. No. 61/020303, filed Jan. 10, 2008, which is incorporated herein by reference in its entirety.

### TECHNICAL FIELD

This disclosure generally relates to the field of automatic data collection (ADC), for example, data acquisition via radio frequency identification (RFID) tags. More particularly but not exclusively, the present disclosure relates to improving the reading of RFID tags by an RFID reader in a noisy environment.

### BACKGROUND INFORMATION

The ADC field includes a variety of different types of ADC data carriers and ADC readers operable to read data encoded in such data carriers. For example, data may be encoded in machine-readable symbols, such as barcode symbols, area or matrix code symbols, and/or stack code symbols. Machine-readable symbols readers may employ a scanner and/or imager to capture the data encoded in the optical pattern of such machine-readable symbols. Other types of data carriers and associated readers exist, for example magnetic stripes, optical memory tags, and touch memories.

Other types of ADC carriers include RFID tags that may store data in a wirelessly accessible memory, and may include a discrete power source (i.e., an active RFID tag), or may rely on power derived from an interrogation signal (i.e., a passive RFID tag). RFID readers typically emit a radio frequency (RF) interrogation signal that causes the RFID tag to respond with a return RF signal encoding the data stored in the memory.

Identification of an RFID device or tag generally depends on RF energy produced by a reader or interrogator arriving at the RFID tag and returning to the reader. Multiple protocols exist for use with RFID tags. These protocols may specify, among other things, particular frequency ranges, frequency channels, modulation schemes, security schemes, and data formats.

Many ADC systems that use RFID tags employ an RFID reader in communication with one or more host computing systems that act as central depositories to store and/or process and/or share data collected by the RFID reader. In many applications, wireless communications is provided between the RFID reader and the host computing system. Wireless communications allow the RFID reader to be mobile, may lower the cost associated with installation of an ADC system, and permit flexibility in reorganizing a facility, for example a warehouse.

RFID tags typically include a semiconductor device (such as a chip) having the memory, circuitry, and one or more conductive traces that form an antenna. Typically, RFID tags act as transponders, providing information stored in the memory in response to the RF interrogation signal received at the antenna from the reader or other interrogator. Some RFID tags include security measures, such as passwords and/or encryption. Many RFID tags also permit information to be written or stored in the memory via an RF signal.

Noise often adversely affects the capability of an RFID reader to accurately read an RFID tag. As an illustration, an RFID reader might transmit a large amount of power, for example 30 dBm of effective radiated power (ERP). Due to impedance mismatches and other factors associated with transmission lines and antennas that cause reflected or standing waves, the antenna of the RFID reader might, for example, have a reflection loss of −15 db (the S11 loss) or higher. Therefore, at an output port of the RFID reader at the antenna, there is a large signal (having a magnitude of at least 15 dBm) that is reflected back into the receiver of the RFID reader. This large reflected signal after being downconverted, can add to the baseband noise level and adversely affect the reading performance of the RFID reader.

The return signal from an RFID tag that reaches the antenna of the RFID reader is often much less than −15 dBm, for instance. Thus, in this illustrated example, the reflected signal having a magnitude of at least 15 dBm is considerably larger than the magnitude of the desired return signal from the RFID tag.

### BRIEF SUMMARY

A radio frequency identification (RFID) reader apparatus may be summarized as including: at least one antenna for communicating with at least one RFID tag; phase shifting means for providing a phase shift to at least one signal present in a receive path downstream from the at least one antenna; and control means for controlling the phase shifting means to adjust a value of the phase shift to minimize noise, associated with the at least one signal, that is present in the receive path.

An RFID reader apparatus may be summarized as including: an antenna to communicate with at least one RFID tag; a phase shift device coupled to the antenna to provide a phase shift to at least one signal present in a receive path downstream from the antenna; and a controller coupled to the phase shift device to control the phase shift device to adjust a value of the phase shift to minimize noise, associated with the at least one signal, that is present in the receive path.

A method to improve a signal-to-noise ratio (SNR) in a receive path of an RFID reader, may be summarized as including: receiving a reflected signal, in the receive path, from an antenna of the RFID reader; receiving a leakage signal in the receive path; providing a local oscillation signal; adding a phase shift to the reflected and leakage signals, or to the local oscillation signal; and mixing at least the reflected, leakage, and local oscillation signals to obtain a sum of low frequency terms associated with noise in the receive path, wherein a value of the phase shift is selected to minimize the sum.

An article of manufacture may be summarized as including a computer-readable medium having instructions stored thereon that are executable by a processor to minimize noise in a receive path of a radio frequency identification (RFID) reader, by: determining a sum of low frequency terms obtained by mixing a reflected signal, in the receive path, from an antenna of the RFID reader, a leakage signal in the receive path, and a local oscillation signal; selecting a value of a phase shift to minimize the sum; and adding the phase shift having the value to the reflected and leakage signals, or to the local oscillation signal, to correspondingly reduce the noise in the receive path.

### BRIEF DESCRIPTION OF THE SEVERAL VIEWS OF THE DRAWINGS

Non-limiting and non-exhaustive embodiments are described with reference to the following drawings, wherein like reference numerals refer to like parts throughout the various views unless otherwise specified. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 shows a block diagram of one embodiment of an RFID reader reading at least one RFID tag.

FIGS. 2-4 are schematic diagrams showing portions of transceiver circuitry of the RFID reader of FIG. 1 according to various embodiments.

FIG. 5 is a schematic diagram of one embodiment of a phase shifter for the transceiver circuitry of FIGS. 3-4.

FIG. 6 is a flowchart depicting one embodiment of a method to read RFID tags in a noisy environment by adjusting phase.

### DETAILED DESCRIPTION

In the following description, numerous specific details are given to provide a thorough understanding of embodiments. The embodiments can be practiced without one or more of the specific details, or with other methods, components, materials, etc. In other instances, well-known structures, materials, or operations associated with RFID tags and RFID readers, computer and/or telecommunications networks, and/or computing systems are not shown or described in detail to avoid obscuring aspects of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Reference throughout this specification and claims to “radio frequency” or RF includes wireless transmission of electromagnetic energy, including, but not limited to, energy with frequencies or wavelengths typically classed as falling in the radio and microwave portions of the electromagnetic spectrum.

The headings provided herein are for convenience only and do not interpret the scope or meaning of the embodiments.

As an overview, an embodiment provides a technique to maximize a signal-to-noise ratio (SNR) at a receiver of an automatic data collection device, such as an RFID reader adapted to read one or more RFID tags in a noisy environment. By improving the SNR, a reader link margin is increased to enable return signal(s) from the RFID tag(s) to be successfully distinguished from noise and successfully decoded. Also, improving the SNR enables a greater number of RFID tags to be read per unit time.

In an embodiment, the SNR is improved by adjusting a phase of at least one signal (such as reflected signal and a leakage signal) received by a mixer of the RFID reader. In another embodiment, the phase of a local oscillation signal can be adjusted by providing a phase shift thereto, instead of adding the phase shift to the reflected and leakage signals. The phase adjustment can be provided by a phase shifter in one embodiment. In another embodiment, the frequency of transmission (and hence the frequency of the at least one signal) can be adjusted, which causes a corresponding phase adjustment if the frequency and phase are closely related. Alternatively or additionally in another embodiment, a reflection coefficient can be adjusted at an antenna of the RFID reader to minimize the noise, thereby improving the SNR.

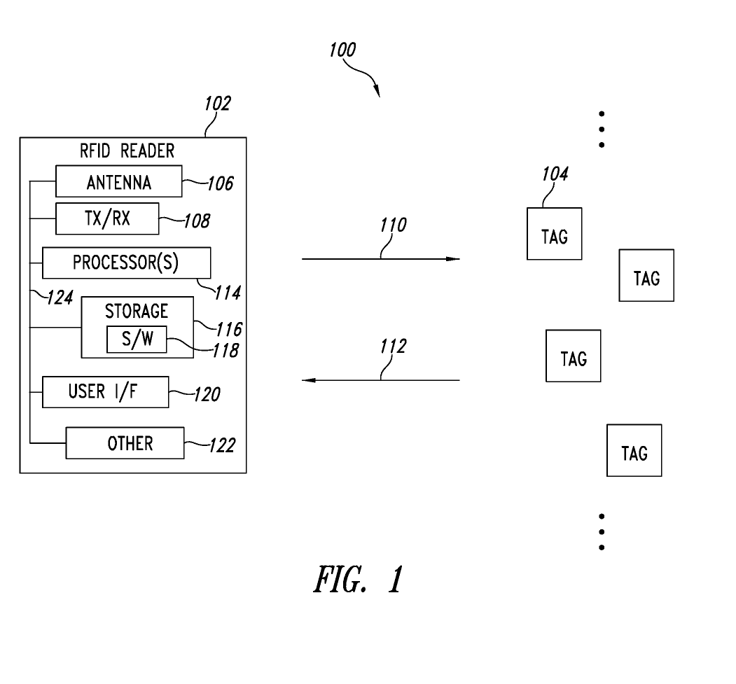

FIG. 1 shows an embodiment an automatic data collection device system 100 in the form of an RFID reader 102 having capability to read one or more RFID tags 104. For simplicity of explanation hereinafter, the RFID reader 102 will be described in the context of being a portable handheld automatic data collection device that is dedicated to reading RFID tags 104. In other embodiments, the automatic data collection device can be a stationary (non-portable) or semi-stationary device (such as attached to a forklift), and/or can be a multi-mode device having the capability to read other types of data carriers (e.g., bar code symbols, image code symbols, etc.) in addition to reading RFID tags.

One embodiment of the RFID reader 102 includes at least one antenna 106 and related transmitter/receiver (“transceiver”) circuitry 108. The antenna 106 and transmitter/receiver circuitry 108 are adapted to send one or more RF interrogation signals 110 to the RFID tag 104, and are adapted to receive one or more RF return signals 112 sent by the RFID tag 104.

In one embodiment, the RFID reader 102 includes a single antenna 106 to both transmit the interrogation signal 110 and to receive the return signal 112. In another embodiment, separate antennas 106 can be provided respectively for transmission and reception. For the sake of simplicity of explanation hereinafter, embodiments will be described with respect to the RFID reader 102 having the single antenna 106 for both transmission and reception. Such various embodiments can be modified as appropriate to provide two separate antennas 106 respectively for transmission and reception.

The RFID reader 102 includes one or more processors 114. The processor 114 is adapted to process the return signals 112 received by the RFID reader 102, as well as to control the operation of various other components of the RFID reader 102. In one embodiment that will be explained later below, the processor 114 is adapted to provide a first adjustment signal to control a phase shift provided by a phase shifter in the transceiver circuitry 108 and/or adapted to provide a second adjustment signal to adjust a frequency of the interrogation signal generated and sent by the transceiver circuitry 108.

In one embodiment, the RFID reader 102 includes a computer-readable storage medium 116 encoded with or otherwise storing instructions. The storage medium 116 can include, for example, one or more memories such as random access memory (RAM), read only memory (ROM), field programmable gate array, flash memory, or other type of memory. The instructions stored in the storage medium 116 can include a computer program in the form of software or firmware, for example. For the sake of illustration, the instructions stored in the storage medium 116 are depicted in FIG. 1 as software 118. In one embodiment, the software 118 is executable by the processor 114 to perform the various operations described herein pertaining to reading the RFID tag 104, adjusting phase and/or frequency, and others.

The RFID reader 102 of one embodiment further includes a user interface 120. The user interface 120 is adapted to receive user commands pertaining to controlling the operation of the RFID reader 102, such as a command to send the interrogation signal 110. The user interface 120 is also adapted to present results of the read operation to the user (such as via a display screen), or to otherwise present audio (e.g., via a speaker), visual (e.g., via one or more LED, OLED, LCD) and/or tactile (e.g., via a vibrator) indicators to the user related to the operation of the RFID reader 102.

The RFID reader 102 includes other components 122 to support operation of the RFID reader 102. Such components 122 can include, for example, a power source (such as a battery), communication components to enable the RFID reader to communicate with an external network/system (such as to download/upload data and software updates), a decrypter to decrypt encrypted information decoded from the received return signals 112, additional memory and/or processors, scanning and/or imaging components if the RFID reader 102 is a multi-mode data collection device, AC plug, and so forth. A decoder to decode information encoded in the received return signals 112 can be present in the components 122 and/or in the transceiver circuitry 108.

One or more buses 124 (e.g., instruction, data, power buses) couple the various components of the RFID reader 102 together.

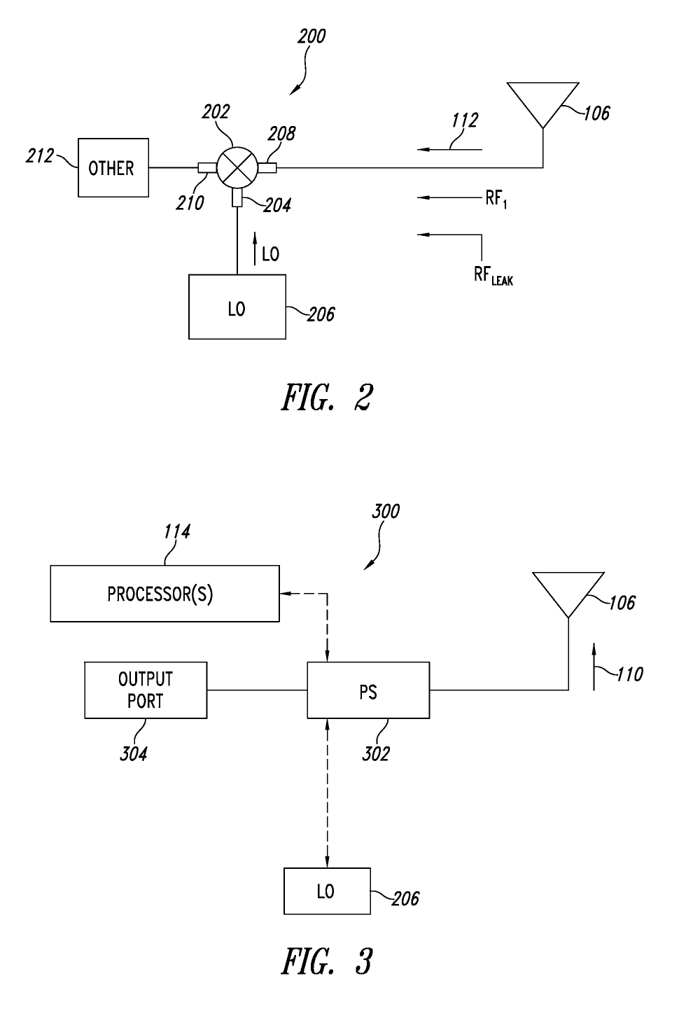

FIG. 2 shows an embodiment of a first portion 200 of the transceiver circuitry 108, specifically components of the transceiver circuitry 108 downstream from the antenna 106. For the sake of brevity and simplicity of explanation, only the components of the transceiver circuitry 108 (as depicted in the first portion 200) that are relevant to understanding the features and operation of one embodiment are described in detail herein. Other components of the transceiver circuitry 108 that are less relevant are not shown or described in detail herein.

The first portion 200 includes a downconversion mixer (multiplier) 202 coupled to the antenna 106. The mixer 202 includes a first (input) port 204 coupled to receive a local oscillation (LO) signal from a local oscillator 206. The mixer 202 includes a second (input) port 208 coupled to the antenna 106. The mixer 202 includes a third (output) port 210 coupled to downstream components of the transceiver circuitry 108, such as a filter, decoder, and/or other components 212.

The LO signal received at the first port 204 of the mixer 202 is often the same frequency and same waveform as the interrogation signal 110 transmitted by the RFID reader 102, but having a different amplitude (e.g., attenuated) and having a different phase. The second port 208 of the mixer 202 receives the return signal 112 from the tag 104 (via the antenna 106), a reflected signal RF₁ from the antenna 106, and a leakage signal RF_{LEAK}. The reflected signal RF₁ is generally caused by impedance mismatches at the antenna 106. The leakage signal RF_{LEAK} at the second port 208 is primarily caused by the coupling of the interrogation signal 110 with an RF output port of the reader 102 though on-board traces, etc.

At the second port 208 of the mixer 202, the input signal can thus be represented as follows (with the response signal 112 omitted for simplicity):

RF₁+RF_{LEAK}.

In a situation wherein no phase shifting is actively provided by a dedicated phase shifter of the transceiver circuitry 108, RF₁ can be represented as acos(wt), and RF_{LEAK} can be represented as bcos(wt+A), wherein a and b are the respective amplitudes of the reflected signal RF₁ and the leakage signal RF_{LEAK}, wherein w is the frequency, and wherein A is a phase difference between the reflected signal RF₁ and the leakage signal RF_{LEAK}. Accordingly, the input signal present at the second port of the mixer 202 can be represented as follows (with the response signal 112 omitted for simplicity):

a cos(wt)+b cos(wt+A) (1).

In this same situation wherein no phase shifting is actively provided by a dedicated phase shifter of the transceiver circuitry 108, the LO signal at the first port 204 of the mixer 202 can be represented as kcos(wt+B) in one channel (I or Q), wherein k is the amplitude of the LO signal, w is the frequency, and B is the phase. The output of the mixer 202 in this situation contains the product of Equation (1) above and the LO signal, and is represented as follows:

[a cos(wt)+b cos(wt+A)] [k cos(wt+B)] (2).

In one embodiment that will be described with respect to FIG. 3, a phase shifter is added to the transceiver circuitry 108 to actively provide a phase shift C to the RF₁ and RF_{LEAK} signals represented in Equation (2) above. Thus, Equation (2) above gets modified in one embodiment to the following:

[a cos(wt+C)+b cos(wt+A+C)] [k cos(wt+B)] (2′).

When the multiplication of Equation (2′) above is carried out, the following results are obtained:

1/2(ak)cos(2wt+B+C)+1/2(ak)cos(B−C)+1/2(bk)cos(2wt+A+B+C)+1/2(bk)cos(A+C−B).

One or more filters (e.g., the other components 212) downstream of the third port 210 of the mixer 202 filter out the high-frequency cos(2wt+ . . . ) terms above. The low frequency terms are given by:

1/2(ak)cos(B−C)+1/2(bk)cos(A+C−B) (3).

The above Equation (3) is proportional to the baseband noise and/or otherwise represents noise. In one embodiment, the phase C can be adjusted to provide Equation (3) with a minimum value, thereby minimizing the noise. It is noted that this downconversion operation represented in part in Equation (3) is performed on one channel (I or Q). For the other channel, the local oscillation signal is ksin(wt+B).

To adjust phase for noise minimization, one embodiment adds a phase shift device or phase shifter in the upstream transmit path between the RF output port of the RFID reader and the antenna 106. One embodiment of such a configuration is shown in FIG. 3.

In FIG. 3, a first terminal of a phase shifter 302 is coupled to the antenna 106, and a second terminal of the phase shifter 302 is coupled to the output port 304 of the RFID reader 102. Accordingly, the interrogation signal 110 sent to the antenna 106 for transmission to the RFID tag 104 has the phase shift C added thereto. In this regard, the reflected signal RF₁ received from the antenna 106 and the received leakage signal RF_{LEAK} will also have the phase shift C introduced thereto, such as represented in Equation (2′) above.

With regards to the LO signal from the local oscillator 206, the phase shift C is not added thereto in an embodiment where the phase shift C is added to the reflected signal RF₁ and leakage signal RF_{LEAK}. In another embodiment, the phase shift C is added to the LO signal, instead of the reflected signal RF₁ and the leakage signal RF_{LEAK}. In such an embodiment, the phase shift C can be added to the LO signal using various techniques. For example, the output of the local oscillator 206 can be coupled to the phase shifter 302, prior to being provided to the first port 204 of the mixer 202, thereby obtaining the phase shift C from the phase shifter 302, while the reflected signal RF₁ and the leakage signal RF_{LEAK} bypass the phase shifter 302 so that these signals are not phase shifted by the phase shifter 302. As yet another example, the local oscillator 206 can be configured to directly generate the LO signal having the phase shift C therein. The LO signal having the phase shift C is symbolically represented in FIG. 3 by broken lines between the local oscillator 206 and the phase shifter 302.

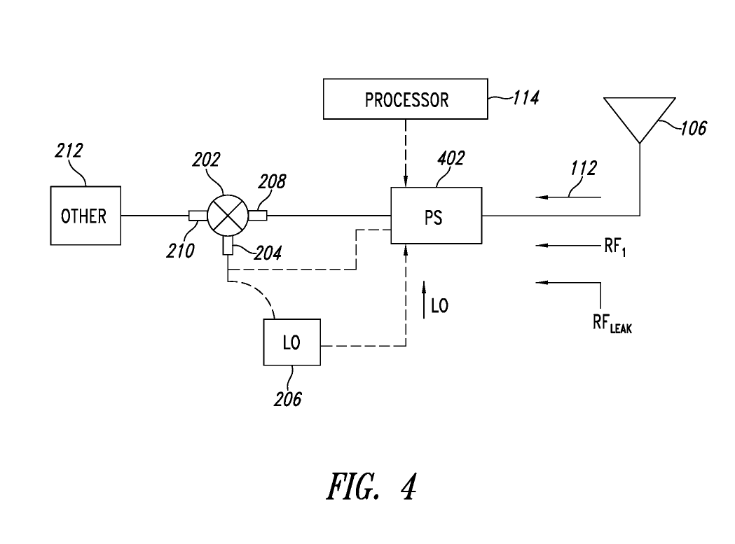

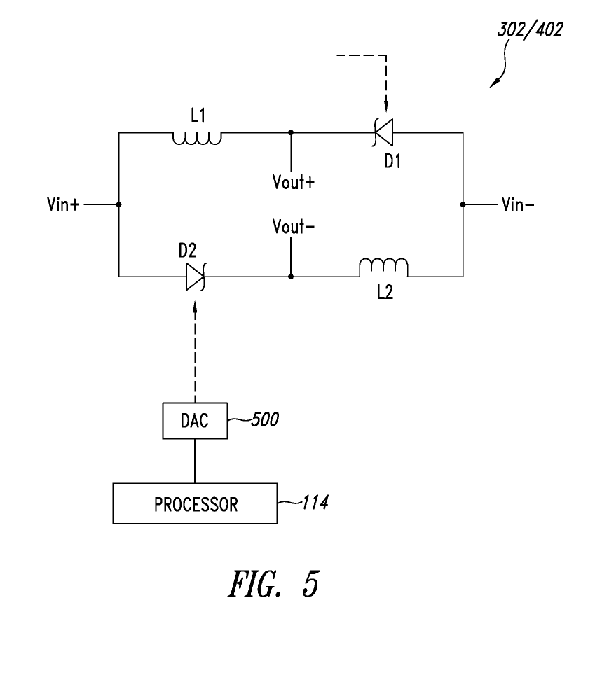

In another embodiment depicted in FIG. 4, a phase shifter 402 is placed in the receive path between the second port 208 of the mixer 202 and the antenna 106. In this arrangement, the phase shift C is introduced into the reflected signal RF₁ and the leakage signal RF_{LEAK} that are input into the second port 208 of the mixer 202 in the receive path, rather than being present in the signal in the transmit path as described with respect to FIG. 3 above. In this arrangement, the LO signal does not include the phase shift C.

With regards to the LO signal from the local oscillator 206 in FIG. 4 for an embodiment that adds the phase shift C to the LO signal instead of to the reflected signal RF₁ and the leakage signal RF_{LEAK}, the phase shift C can again be introduced into the LO signal in the manner described above with respect to FIG. 3, including providing an output of the local oscillator 206 into the phase shifter 402 (while the reflected signal RF₁ and the leakage signal RF_{LEAK} bypass the phase shifter 402), so as to generate the LO signal having the phase shift C therein as input into the first port 204 of the mixer 202 or directly generating the LO signal having the phase shift C therein. The LO signal having the phase shift C is also symbolically represented in FIG. 4 by broken lines.

In one embodiment, the value of the phase shift C is adjustable. This adjustment can be manual, for example, performed by a user of the RFID reader 102 based on feedback signals or other indications of noise level provided by the user interface 122. The adjustment provided by the user can be processed by the processor 114 to correspondingly control the phase shifter 302/402. Alternatively or additionally, the adjustment can be performed automatically by the processor 114. For instance, the processor 122 can be programmed with Equation (3) above and can generate an adjustment signal to adjust C to minimize Equation (3) as determined by the values of a, b, and k (and even A and/or B) that are monitored by the processor and that might change dynamically. Control of the phase shifter 302/402 by the processor 114 to adjust the phase shift C is also symbolically represented in FIGS. 3-4 by broken lines.

One embodiment of the phase shifter 302/402 can be implemented by the circuit shown in FIG. 5. Specifically in the depicted embodiment, the phase shifter 302/402 includes a parallel combination of two varactors each respectively coupled in series with an inductor. The varactors are each represented by a diode D1 and a diode D2, and the inductors are each represented as an inductor L1 and an inductor L2 coupled respectively in series with the diodes D1 and D2.

In FIG. 5, the magnitude of the voltage Vout is the same as the magnitude of the voltage Vin, but these voltages are separated by a phase difference tan⁻¹(X_{L}/X_{C}). The phase difference tan⁻¹(X_{L}/X_{C}) corresponds to the phase shift C, wherein X_{L} is the inductive reactance and X_{C} is the capacitive reactance.

The varactors of one embodiment are controlled by the first adjustment signal provided by the processor 114 in cooperation with the software 118, to thereby adjust the phase shift C. The first adjustment signal from the processor 114 is converted in one embodiment from a digital signal to an analog signal by a digital-to-analog converter (DAC) 500 coupled to the processor 114. Control of the varactors by the first adjustment signal from the DAC 500 is represented in FIG. 4 by broken lines. The DAC 500 may form part of the transceiver circuitry 108 and/or may be one of the other components 122.

In other embodiments, the phase shifter 302/402 can be provided with other elements and/or configuration than what is depicted in FIG. 5.

As described above, noise at the transceiver 108 of the RFID reader 102 can be reduced by appropriately adding and adjusting the phase shift C, thereby maximizing the signal-to-noise ratio at the transceiver 108 of the RFID reader 102. Alternatively or additionally in one embodiment, noise can be reduced by selectively changing the frequency w. That is, the phase and the frequency w are closely related in one embodiment. Thus, by changing the frequency, the phase is also varied with the changing of the frequency—this therefore provides an effect somewhat analogous to using the phase shifter 302/402 to actively introduce the phase shift C.

In one embodiment, the processor 114 is adapted to provide the second adjustment signal to the transceiver circuitry 108 to change the frequency w, thereby also changing phase in situations where the frequency is closely related to the phase. The transceiver circuitry 108 can include an adjustable frequency generator or other device to cause a phase shift in such an embodiment that is responsive to the second adjustment signal to vary frequency.

In one embodiment, modification of a reflection coefficient at a port of the antenna 106 can also be performed additionally or alternatively to the above-described phase shifting, in order to minimize noise. That is, one embodiment modifies the reflection coefficient at the port of the antenna 106 so as to obtain the least amount of reflected signal RF₁, which can occur for instance when the output impedance of the RFID reader 102 is different from the impedance of the antenna 106 (for example, 50 ohms).

The reflection coefficient R at the antenna 106 is given by the following relation:

R=(Zout−Za*)/(Zout+Za) (4),

wherein Zout is the output impedance of the RFID reader 102 (i.e., the impedance when looking into the output port 304 of FIG. 3 from the antenna 106), Za is the impedance of the antenna 106 (i.e., the impedance when looking into the antenna 106 from the output port 304 of FIG. 3), and Za* is the complex conjugate of the impedance Za of the antenna 106.

If the phase shifter 302 is present between the reader output port 304 and the antenna 106, then for a change θ in phase, the impedance Za-modified looking into the phase shifter 302 from the output port 304 is given by the following:

Za-modified=Zo[(Za)cos(θ)+j(Zo)sin(θ)]÷[(Zo)cos(θ)+j(Za)sin(θ)] (5),

wherein Zo is the impedance of the transmission line between the output port 304 and the antenna 106.

The reflection coefficient R at the antenna 106, given by Equation (4) above, changes by replacing the impedance Za of the antenna 106 with Za-modified from Equation (5). Accordingly, by adjusting the value of θ using the phase shifter 302/402, the reflection coefficient R can be modified to have a value that minimizes the reflected signal RF₁. In effect, adjusting the reflection coefficient R attempts to match impedances so as to minimize signal reflection.

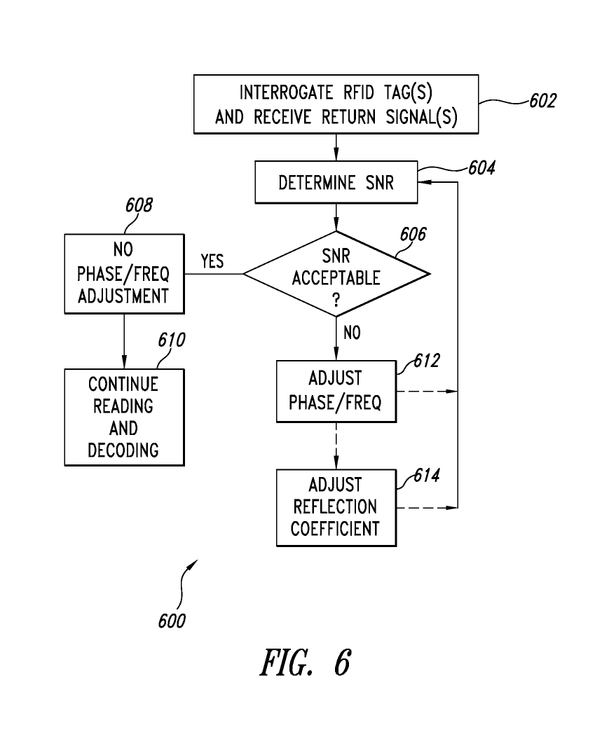

FIG. 6 is a flowchart of an embodiment of a method 600 that can be performed by the RFID reader 102 to improve the reading of one or more RFID tag(s) 104 in a noisy environment, using phase shifting as explained above. In one embodiment, one or more operations in the method 600 can be performed by software or other computer-readable instructions encoded in or otherwise stored in a computer-readable medium and executed by a processor. For instance, such operations may be embodied in instructions stored in the storage medium 116 and executed by the processor 114. In another embodiment, one or more operations in the method 600 can be performed by hardware singly or in combination with software or other computer-readable instructions executed by the processor 114.

The various operations depicted in FIG. 6 need not necessarily occur in the exact order shown. Moreover, various operations may be added, removed, combined, and/or modified.

At a block 602, the RFID reader 102 attempts to read one or more RFID tags 104 by generating and sending the interrogation signal 110 and receiving the return signal(s) 112 from the RFID tag(s) 104 at the antenna 106. As previously explained above, sending the interrogation signal 110 causes the generation of the return signal RF₁ and the leakage signal RF_{LEAK} in the receive path of the RFID reader 102. Accordingly, the return signal RF₁ and the leakage signal RF_{LEAK} contribute to noise at the transceiver 108 of the RFID reader 102.

At blocks 604-606, the processor 114 of one embodiment determines whether the signal-to-noise ratio (SNR) is at an acceptable level to enable the return signal 112 to be successfully decoded. Alternatively or additionally in another embodiment, other circuitry of the RFID reader 102 can be used at the blocks 604-606 to determine the SNR and/or to otherwise determine the level of noise and the degree of impact of the noise on the received return signal 112.

If the SNR is determined to be at an acceptable level at the blocks 604-606, then no adjustment of phase and/or frequency is performed at a block 608. For example, the processor 114 does not generate or change the first adjustment signal to adjust the phase shift C of the phase shifter 302/402, if the SNR is acceptable. The RFID reader 610 can thus continue to read, decode, etc. the RFID tag(s) 104 at a block 610.

If the SNR is determined to be at an unacceptable level at the blocks 604-606, then the phase and/or frequency is adjusted at a block 612. For example, in an embodiment that uses frequency hopping wherein the frequency w of the interrogation signal 110 is changed within a single frequency band from one frequency to another over time, the phase shift C of the phase shifter 302 of FIG. 3 can be adjusted to minimize noise at each given frequency via the first adjustment signal from the processor 114. In another embodiment, such as shown in FIG. 4 wherein the phase shifter 402 is placed in the receive path, noise can be minimized by adjusting the phase of the signals coming into the mixer 202 via the first adjustment signal from the processor 114—in this manner, the noise level in the baseband channel is altered and all channels will have low received noise.

Alternatively or additionally in another embodiment, the frequency at each hop can be slightly varied via the second adjustment signal from the processor 114 to produce a slight change in the phase, since as explained above, the frequency and phase are closely tied to each other. Embodiments of a frequency hopping method in which such phase/frequency adjustments can be implemented to improve the SNR are disclosed in U.S. Patent Application Publication No. 20050179521, entitled “FREQUENCY HOPPING METHOD FOR RFID TAG,” assigned to the same assignee as the present application, and incorporated herein by reference in its entirety.

Still alternatively or additionally in another embodiment involving frequency hopping, a particular frequency (within the frequency band) that provides the best SNR performance is selected. Thereafter, the subsequent frequency hops can be slight variations (above or below) from this particular frequency so as to obtain the best possible SNR performance for these other frequencies.

For non-hopping implementations that use an initially fixed frequency, the method 600 attempts to start interrogation at a phase and/or frequency corresponding to the lowest received noise (if such a frequency is available), and then makes adjustments to phase and/or frequency at the block 612 if appropriate to obtain better SNR performance.

Alternatively or additionally to the adjustment of phase and/or frequency at the block 612, the reflection coefficient R can be adjusted by the RFID reader 102 at a block 614. As explained above, adjusting the reflection coefficient R in one embodiment involves adjusting the value of θ in Equation (4) having Za-modified of Equation (5) therein, using the phase shifter 302/402.

The adjustment of the phase/frequency at the block 612 alternatively or additionally to adjustment of the reflection coefficient R at the block 614 is depicted in FIG. 6 by broken lines. From the adjustment(s), the value of the resulting SNR can be re-evaluated at the block 604 to determine if the sufficiency of the adjustment(s).

The sufficiency of the adjustment(s) and SNR at the block 604 can be based on a number of considerations. For example, if the RFID reader 102 is attempting to read one or more tags in a noisy environment, an acceptable level of SNR can be deemed to be a level that provides adequate reader link margin, in which the return signals 112 of the tags are successfully read and distinguished from noise. Alternatively or additionally, an acceptable level of SNR can be deemed to be a level that provides better throughput, in which more tags can be successfully read per unit time, as compared to a poorer SNR that reads a lesser number of tags successfully per unit time.

Examples of improved throughput are provided below in an illustrative, non-limiting, and non-exhaustive situation that attempts to read 270 tags in a pallet, wherein values are provided for the phase shift, the noise in the I and Q channels (e.g., a peak-to-peak measurement in which a decreased value represents a lesser amount of noise in the channel), and the number of tags that are read. From this example, it is seen that as the noise in the I and Q channels comes down, more tags are read:

Phase shift=22.5; I-Q channel noise=250, 300; and the number of tags read=179; and

Phase shift=122.5; I-Q channel noise=100, 150; and the number of tags read=187.

Thus, it is seen that the when the phase shifter 302/402 is set to minimize the noise, the number of tags read is maximized or otherwise increased.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, including but not limited to U.S. provisional patent application Ser. No. 61/020303, filed Jan. 10, 2008 and U.S. Patent Application Publication No. 20050179521, are incorporated herein by reference, in their entirety. Aspects of the embodiments can be modified, if necessary to employ concepts of the various patents, applications and publications to provide yet further embodiments.

For instance, the mathematics represented in Equation (2′) and in Equation (3) above, and in the results thereof, can be modified appropriately in an embodiment wherein the phase shift C is added to the LO signal instead of to the reflected signal RF₁ and the leakage signal RF_{LEAK}.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A radio frequency identification (RFID) reader apparatus, comprising:
at least one antenna to communicate with at least one RFID tag;
phase shifting means for providing a phase shift to at least one signal present in a receive path downstream from the at least one antenna; and
control means for controlling the phase shifting means to adjust a value of the phase shift to minimize noise, associated with the at least one signal, that is present in the receive path.

2. The apparatus of claim 1, further comprising mixing means in the receive path for mixing a local oscillation signal with the at least one signal present in the receive path, wherein the at least one signal includes a reflected signal from the at least one antenna and a leakage signal, wherein the phase shifting means is located between the at least one antenna and the mixing means to add the phase shift to the reflected signal and to the leakage signal, the mixing means having as inputs the reflected and leakage signals having the phase shift added thereto and the local oscillation signal.

3. The apparatus of claim 1, further comprising mixing means in the receive path for mixing a local oscillation signal with the at least one signal present in the receive path, wherein the phase shifting means is located in an upstream transmit path between an output port and the at least one antenna to add the phase shift to an interrogation signal provided from the output port, wherein the at least one signal includes a portion of the interrogation signal having the phase shift reflected from the at least one antenna and a leakage signal having the phase shift, the mixing means having as inputs the reflected and leakage signals having the phase shift added thereto and the local oscillation signal.

4. The apparatus of claim 1 wherein the phase shifting means also modifies a reflection coefficient at the at least one antenna to further minimize noise in the receive path and wherein the control means controls the phase shifting means to adjust the value of the phase shift by controlling a transmit frequency.

5. A radio frequency identification (RFID) reader apparatus, comprising:
at least one antenna to communicate with at least one RFID tag;
a phase shift device coupled to the at least one antenna to provide a phase shift to at least one signal present in a receive path downstream from the at least one antenna; and
a controller coupled to the phase shift device to control the phase shift device to adjust a value of the phase shift to minimize noise, associated with the at least one signal, that is present in the receive path.

6. The apparatus of claim 5, further comprising a mixer in the receive path to mix a local oscillation signal with the at least one signal present in the receive path, wherein the at least one signal includes a reflected signal from the at least one antenna and a leakage signal, wherein the phase shift device is located between the at least one antenna and the mixer to add the phase shift to the reflected signal and to the leakage signal, the mixer having as inputs the reflected and leakage signals having the phase shift added thereto and the local oscillation signal.

7. The apparatus of claim 6 wherein the phase shift device is also adapted to modify a reflection coefficient at the at least one antenna to further minimize noise in the receive path.

8. The apparatus of claim 5, further comprising a mixer in the receive path to mix a local oscillation signal having with the at least one signal present in the receive path, wherein the phase shift device is located in an upstream transmit path between an output port and the at least one antenna to add the phase shift to an interrogation signal provided from the output port, wherein the at least one signal includes a portion of the interrogation signal having the phase shift reflected from the at least one antenna and a leakage signal having the phase shift, the mixer having as inputs the reflected and leakage signals having the phase shift added thereto and the local oscillation signal.

9. The apparatus of claim 8 wherein the phase shift device is also adapted to modify a reflection coefficient at the at least one antenna to further minimize noise in the receive path.

10. The apparatus of claim 5 wherein the controller is adapted to control the phase shift device to adjust the value of the phase shift by control of a transmit frequency.

11. The apparatus of claim 5 wherein the at least one antenna is adapted to transmit an interrogation signal to the at least one RFID tag using a plurality of different transmit frequencies in a same frequency band over time, the controller being adapted to vary each transmit frequency to corresponding adjust the value of the phase shift for each the transmit frequency.

12. The apparatus of claim 5 wherein the at least one antenna is adapted to transmit an interrogation signal to the at least one RFID tag at an initially fixed transmit frequency, the transmit frequency having its phase and/or frequency being adjustable by the controller to minimize noise in the receive path.

13. A method to improve a signal-to-noise ratio (SNR) in a receive path of a radio frequency identification (RFID) reader, the method comprising:
receiving a reflected signal, in the receive path, from at least one antenna of the RFID reader;
receiving a leakage signal in the receive path;
providing a local oscillation signal;
adding a phase shift to the reflected and leakage signals, or to the local oscillation signal; and
mixing at least the reflected, leakage, and local oscillation signals to obtain a sum of low frequency terms associated with noise in the receive path, wherein a value of the phase shift is selected to minimize the sum.

14. The method of claim 13 wherein adding the phase shift includes adding the phase shift in an upstream transmit path from an output port of the RFID reader to the at least one antenna.

15. The method of claim 14 wherein adding the phase shift includes adjusting a transmit frequency of the RFID reader to correspondingly change a phase of the reflected signal.

16. The method of claim 13 wherein adding the phase shift includes adding the phase shift in the receive path, downstream from the at least one antenna and before the mixing.

17. The method of claim 16, further comprising modifying a reflection coefficient at the at least one antenna to reduce the reflected signal.

18. The method of claim 13 wherein adding the phase shift includes adjusting a transmit frequency of the RFID reader to correspondingly change a phase of the reflected signal.

19. The method of claim 13, further comprising sending an interrogation signal to at least one RFID tag at a plurality of different transmit frequencies in a same frequency band over time, wherein adding the phase shift includes varying a phase of each of the transmit frequencies.

20. The method of claim 13, further comprising sending an interrogation signal to at least one RFID tag at a plurality of different transmit frequencies in a same frequency band over time, wherein adding the phase shift includes varying each of the transmit frequencies.

21. The method of claim 13, further comprising sending an interrogation signal to at least one RFID tag at an initially fixed transmit frequency, wherein adding the phase shift includes varying a phase and/or frequency of the interrogation signal.

22. An article of manufacture, comprising:
a computer-readable medium having instructions stored thereon that are executable by a processor to minimize noise in a receive path of a radio frequency identification (RFID) reader, by:
determining a sum of low frequency terms obtained by mixing a reflected signal, in the receive path, from at least one antenna of the RFID reader, a leakage signal in the receive path, and a local oscillation signal;
selecting a value of a phase shift to minimize the sum; and
adding the phase shift having the value to the reflected and leakage signals, or to the local oscillation signal, to correspondingly reduce the noise in the receive path.

23. The article of manufacture of claim 22 wherein the instructions executable by the processor to minimize by adding the phase shift include instructions executable by the processor to minimize noise, by:
adding the phase shift in an upstream transmit path.

24. The article of manufacture of claim 22 wherein the instructions executable by the processor to minimize noise by adding the phase shift include instructions executable by the processor to minimize noise, by:
adding the phase shift downstream of the at least one antenna in the receive path.

25. The article of manufacture of claim 23 wherein the computer-readable medium further includes instructions executable by the processor to minimize noise, by:
modifying a reflection coefficient at the at least one antenna of the RFID reader.
